(19) United States
(12) Patent Application Publication
(10) Pub. No.: US 2017/0168999 A1
(43) Pub. Date: Jun. 15, 2017

(54) TRANSLATING WEB APPLICATIONS BASED ON A CONTEXT MODEL

(71) Applicant: International Business Machines Corporation, Armonk, NY (US)

(72) Inventors: Xiao Long Chen, Beijing (CN); Wei-Te Chiang, Taipei (TW); Jia Yu Hu, New Taipei City (TW); Na Lv, Beijing (CN); Xi Ning Wang, Beijing (CN); Zhe Yan, Beijing (CN); Zhuo Zhao, Beijing (CN)

(21) Appl. No.: 14/967,656

(22) Filed: Dec. 14, 2015

(51) Int. Cl. G06F 17/22; G06F 17/28

(52) U.S. Cl. CPC G06F 17/2247; G06F 17/2809; G06F 17/2854

(57) ABSTRACT

A method for translating a webpage includes receiving an HTML package comprising one or more HTML files and one or more corresponding program integrated information (PII) files, identifying elements corresponding to the one or more HTML files to be translated into a target language, creating a mapping file corresponding to the identified elements, wherein the mapping file indicates a PII file to which each identified element corresponds as well as context information corresponding to each PII file, translating the PII files indicated by the mapping file into a target language to provide translated PII files, and replacing untranslated PII files in the HTML package with corresponding translated PII files to provide a translated package.

### BACKGROUND OF THE INVENTION

The present invention relates generally to the field of web content translation, and more specifically to translating web applications based on a context model.

Globalization refers to the process of businesses and technologies spreading throughout the world. A hurdle to globalization in any field is the language barrier that needs to be overcome anytime countries that speak largely different languages are involved. With web content taking on an important role in many businesses and technical fields, it is important to be able to effectively and efficiently translate web applications.

### SUMMARY

A method for translating a webpage includes receiving an HTML package comprising one or more HTML files and one or more corresponding program integrated information (PII) files, identifying elements corresponding to the one or more HTML files to be translated into a target language, creating a mapping file corresponding to the identified elements, wherein the mapping file indicates a PII file to which each identified element corresponds as well as context information corresponding to each PII file, translating the PII files indicated by the mapping file into a target language to provide translated PII files, and replacing untranslated PII files in the HTML package with corresponding translated PII files to provide a translated package. A computer program product and computer system corresponding to the method are also disclosed.

### BRIEF DESCRIPTION OF THE DRAWINGS

FIG. 1 is a block diagram depicting one embodiment of a web application translation system in accordance with one or more embodiments of the present invention;

FIG. 2 is a flowchart depicting one embodiment of a web application translation method in accordance with one or more embodiments of the present invention;

FIG. 3 depicts an example HTML file mapping in accordance with one embodiment of the present invention; and

FIG. 4 depicts a block diagram of components of a computer, in accordance with one or more embodiments of the present invention.

### DETAILED DESCRIPTION

Program integrated information is user-visible text that is contained within a software program and is integral to the execution of that program. In this context, “contained within” means accessible by running the software, and “integral to execution” means used in the execution of the software. Traditionally, this has meant messages, contextual help, and extended help information. The introduction of new human-computer interaction technologies broadens this to include active elements such as intelligent agents, coaches, and wizards.

In order to support web application translation, in many cases user interface messages need to be translated. In these cases, only files containing program integrated information, hereinafter referred to as PII files, are passed on to either a translation service or a translation team to be edited. The translation service or translation team may be unable to discern any context information from only the PII file, and it is therefore possible to make a bad translation.

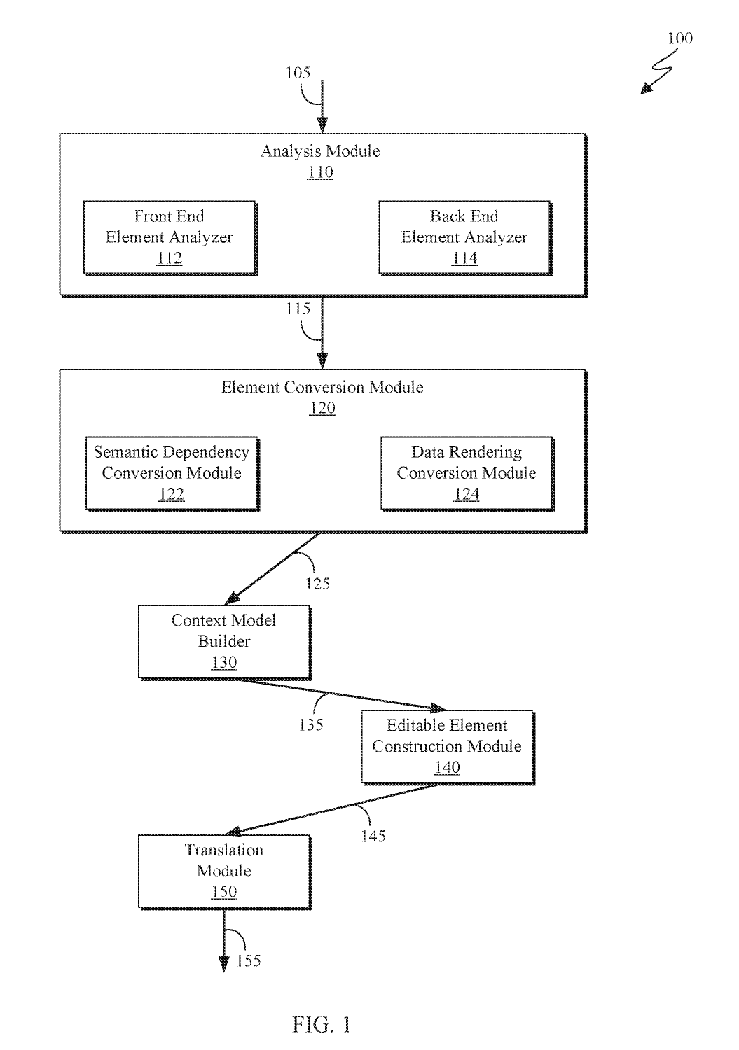

FIG. 1 is a block diagram depicting one embodiment of a web application translation system 100 in accordance with some embodiments of the present invention. As depicted, web application translation system 100 includes an analysis module 110, an element conversion module 120, a context model builder 130, an editable element construction module 140, and a translation module 150. Web application translation system 100 may enable accurate and efficient translation of web applications and web content.

Analysis module 110 may be configured to receive HTML page information 105 and identify elements corresponding to the HTML page information 105 that need to be translated. HTML page information 105 may include HTML pages and corresponding PII files. As depicted, analysis module 110 includes front end element analyzer 112 and back end element analyzer 114. Front end element analyzer 112 is configured to identify front end elements that require translation. Front end elements may correspond to a navigation structure, page layout, a logo, images, or other graphic design elements. Back end analyzer 114 is configured to identify back end elements that require translation. Back end elements are elements that enable a web page or application to be created dynamically, sometimes in response to a user input. For example, back end elements enable a web page to display unique search results to a user in response to his/her search query. Back end elements may include a content management system, shopping cart, site search, blog feature, image rotation, chatroom, contact form, or other elements. In the depicted embodiment, analysis module 110 provides translation elements 115, which are the elements corresponding to HTML page information 105 that require translation.

Element conversion module 120 may be configured to receive translation elements 115 from analysis module 110. As depicted, element conversion module 120 includes semantic dependency conversion module 122 and data rendering conversion module 124. In the depicted embodiment, element conversion module 120 is configured to generate and convert rendered HTML files corresponding to the translation elements 115.

Semantic dependency conversion module 122 may be configured to identify translation elements that refer to the same PII keys. Once identified, the rendered HTML files may be updated to reflect dependencies from the identified translation elements to the corresponding PII keys. Updating the HTML files to reflect the dependencies provides a framework for a map from the translation elements to the corresponding PII keys.

Data rendering conversion module 124 may be configured to analyze a service call chain corresponding to the HTML files. With respect to the depicted embodiment, analyzing the service call chain includes searching the service call chain for related data corresponding to the HTML files, as well as any PII files corresponding to the related data. Data rendering conversion module 124 may further be configured to update the HTML files to include the located PII files.

Context model builder 130 may be configured to receive updated HTML files 125. In some embodiments, context model builder 130 is configured to store context information corresponding to the HTML files. The context information may include selected rendered HTML files or mappings from HTML elements to PII keys. In the depicted embodiment, context model builder 130 is configured to collect updated HTML files and to generate a mapping file indicating a map from translation elements to PII files.

Editable element construction module 140 may be configured to construct editable elements corresponding to the translation elements 125. In some embodiments, the identified translation elements 125 are not in formats that are explicitly editable, which can make translation difficult. In said embodiments, editable element construction module 140 is configured to create editable elements 145 corresponding to the translation elements 125. The editable elements 145 may be created in a format that translation module 150 is capable of processing and editing.

Translation module 150 may be configured to receive the editable elements 145. Translation module 150 may be any translation software or application known in the art. In some embodiments, translation module 150 is configured to translate content in the translation PII files 145 from a current language to a target language. With respect to the depicted embodiment, the translated PII files are merged back into an HTML package alongside any unedited PII files, and provided as a translated package 155.

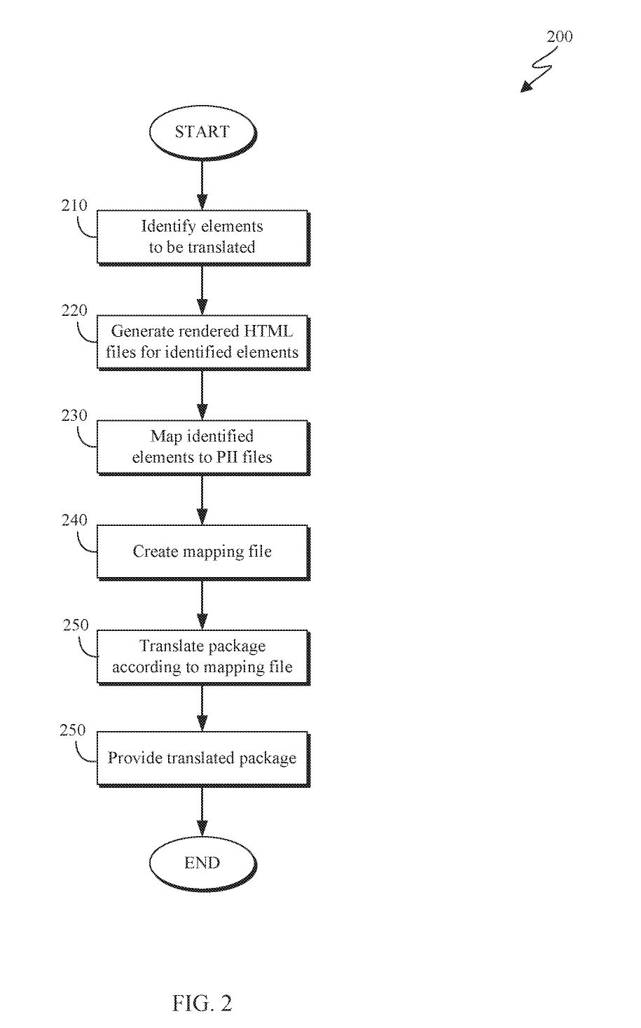

FIG. 2 is a flowchart depicting one embodiment of a web application translation method 200 in accordance with some embodiments of the present invention. As depicted, web application translation method 200 includes identifying (210) elements to be translated, generating (220) rendered HTML files corresponding to the identified elements, mapping (230) identified translation elements to PII files, creating (240) a mapping file, translating (250) an HTML package according to the mapping file, and providing (260) the translated package. Web application translation method 200 may enable efficient and accurate translation of HTML pages.

Identifying (210) elements to be translated within a web application may include receiving one or more HTML pages corresponding to the web application. The received HTML pages may each comprise a plurality of elements, both front end and back end, as defined with respect to FIG. 1. Identifying (210) elements to be translated may include determining which elements comprise text that is not in a selected language. The identified elements, referred to hereafter as translation elements, may be provided to a rendering engine. In some embodiments, the transition elements correspond only to elements that are viewable by a user, and not to elements within code corresponding to the web application.

Generating (220) rendered HTML files corresponding to the identified elements may include rendering any HTML files in which the identified translation elements are embedded. In one embodiment, generating (220) rendered HTML files comprises processing the HTML files and associated formatting information (such as PII files) to display formatted content. In some embodiments, a rendering engine and a layout engine may work in tandem to process and display the rendered HTML files.

Mapping (230) identified translation elements to PII files may include determining which translation elements correspond to which PII files. In other words, mapping (230) identified translation elements may include determining which PII files correspond to the rendering of which translation elements. In some embodiments, multiple translation elements may correspond to the same PII file. Mapping (230) identified translation elements may further include tagging the translation elements with the name of the corresponding PII file. In some embodiments, mapping (230) identified translation elements includes providing mapping information indicating which translation elements correspond to each PII file.

Creating (240) a mapping file may include receiving mapping information. In some embodiments, creating (240) a mapping file comprises processing the mapping information to provide a mapping file indicating which PII file corresponds to render each translation element. The mapping file may be utilized to determine which PII files must be updated to ensure all translation elements are addressed. In some embodiments, the mapping file can be edited iteratively to incorporate updates as HTML pages are received. The mapping file may additionally include context information corresponding to each PII file. The context information may include selected rendered HTML files in addition to the mapping information. The context information may enable a translation team to provide an accurate translation of a text with respect to the context in which the text appears.

Translating (250) an HTML package according to the mapping file may include receiving the mapping file and any PII files referenced in the mapping file. A translation service configured to utilize any translation tool known in the art may translate the received PII files into a target language. In some embodiments, translating the HTML package comprises opening the PII files and translating text within the PII files from a current language to a target language. In some embodiments, a markup table specific to a PII file type is used to identify words that require translation. The identified words may be translated using existing translation software or by a translation team.

Providing (260) the translated package may include receiving the translated PII files. In some embodiments, the translated PII files are merged back into the HTML package alongside any unedited files. Providing the translated package may additionally include replacing untranslated PII files in the HTML package with translated PII files. Providing (260) the translated package may include verifying the translation before it is finalized. Once deemed valid, the translated package may be provided to a user or other application.

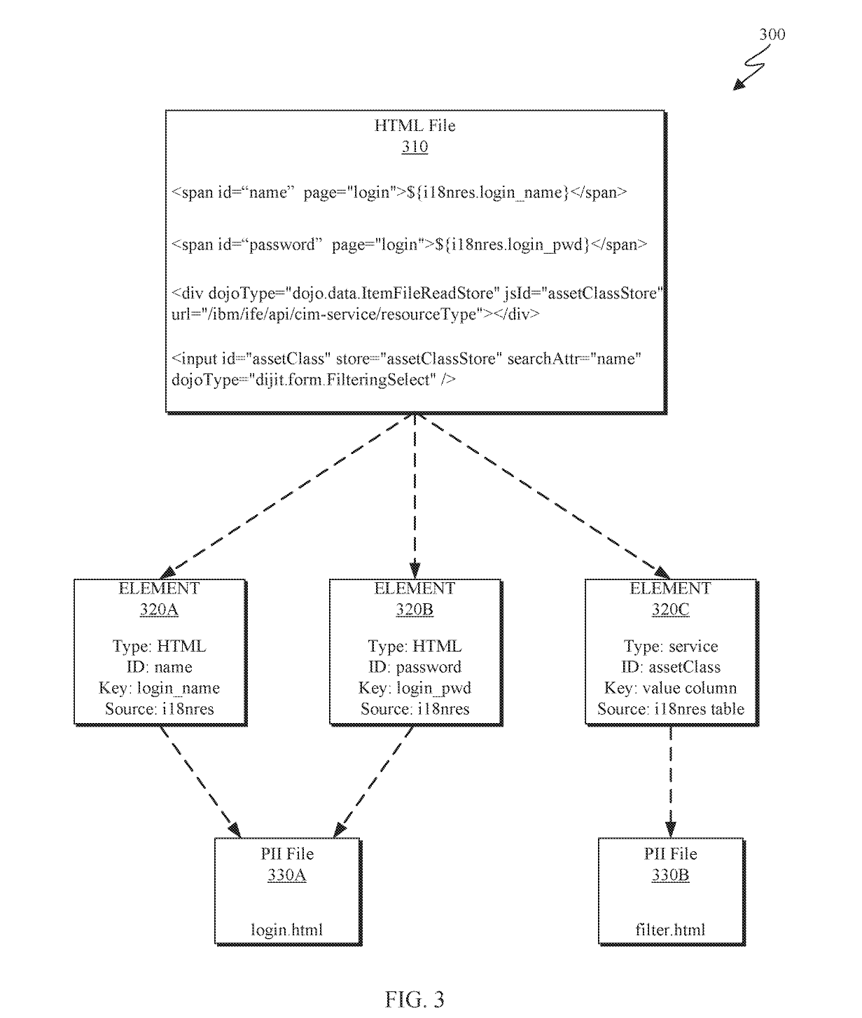

FIG. 3 depicts an example HTML file mapping 300 in accordance with one embodiment of the present invention. As depicted, HTML file mapping 300 includes HTML file 310, HTML elements 320, and PII files 330. HTML file 310 comprises a plurality of commands corresponding to an HTML page. Each command corresponds to an HTML element 320, as depicted. The HTML elements indicate key features of the commands to which they correspond. In the depicted embodiment, the HTML elements indicate a type of command, a command ID, a command key, and a command source corresponding to each command. Each HTML element corresponds to a PII file 330 from which it stems. As depicted, element 320A and element 320B correspond to PII file 330A, while element 320C corresponds to PII file 330B. Elements 320A and 320B stem from the same PII file 330A as they share a common source, as indicated by the source section in the elements. The PII files 330 that correspond to HTML elements 320 are the PII files to be translated to provide a comprehensive translation of HTML file 310.

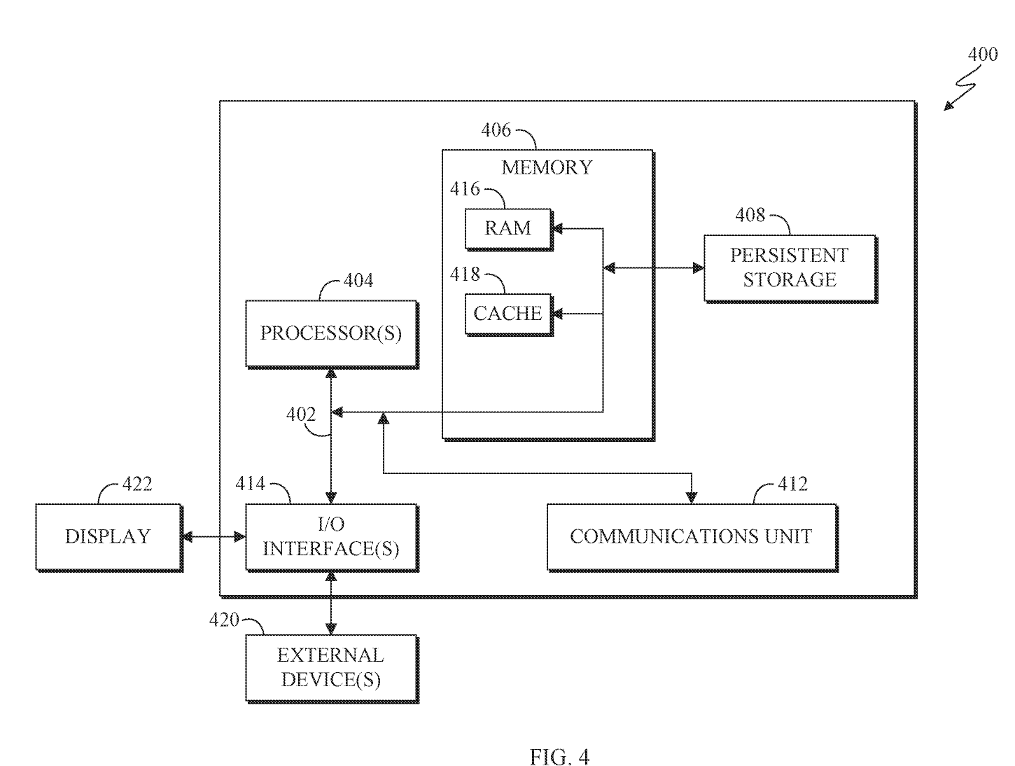

FIG. 4 depicts a block diagram of components of computer 400 in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

As depicted, the computer 400 includes communications fabric 402, which provides communications between computer processor(s) 404, memory 406, persistent storage 408, communications unit 412, and input/output (I/O) interface(s) 414. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 416 and cache memory 418. In general, memory 406 can include any suitable volatile or non-volatile computer-readable storage media.

One or more programs may be stored in persistent storage 408 for access and/or execution by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 412, in these examples, provides for communications with other data processing systems or devices. In these examples, communications unit 412 includes one or more network interface cards. Communications unit 412 may provide communications through the use of either or both physical and wireless communications links.

I/O interface(s) 414 allows for input and output of data with other devices that may be connected to computer 400. For example, I/O interface 414 may provide a connection to external devices 420 such as a keyboard, keypad, a touch screen, and/or some other suitable input device. External devices 420 can also include portable computer-readable storage media such as, for example, thumb drives, portable optical or magnetic disks, and memory cards. Software and data used to practice embodiments of the present invention can be stored on such portable computer-readable storage media and can be loaded onto persistent storage 408 via I/O interface(s) 414. I/O interface(s) 414 also connect to a display 422.

Display 422 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method comprising:
receiving an HTML package comprising one or more HTML files and one or more corresponding program integrated information (PII) files;
identifying elements corresponding to the one or more HTML files to be translated into a target language;
creating a mapping file corresponding to the identified elements, wherein the mapping file indicates a PII file to which each identified element corresponds as well as context information corresponding to each PII file;
translating the PII files indicated by the mapping file into a target language to provide translated PII files; and
replacing untranslated PII files in the HTML package with corresponding translated PII files to provide a translated package.

2. The method of claim 1, wherein identifying elements within the one or more HTML files to be translated comprises identifying elements that correspond to an HTML file that is configured to display text in a language other than the target language to a user.

3. The method of claim 1, wherein providing the translated package comprises providing the translated package to a rendering engine.

4. The method of claim 1, wherein translating the PII files indicated by the mapping file comprises:
identifying a set of words within the indicated PII files that will be seen by a user when the corresponding HTML files are rendered; and
translating the set of words into a target language.

5. The method of claim 1, further comprising verifying the translated package.

6. The method of claim 1, wherein context information corresponding to each PII file may include selected rendered HTML files corresponding to the PII file.

7. The method of claim 1, wherein creating a mapping file corresponding to the identified elements comprises:
identifying PII keys which correspond to multiple elements;
identifying PII keys corresponding to related data in the HTML package; and
creating a mapping file including all the identified PII keys and the elements to which they correspond.

8. A computer program product comprising:
one or more computer readable storage media and program instructions stored on the one or more computer readable storage media, the program instructions comprising instructions to:
receive an HTML package comprising one or more HTML files and one or more corresponding program integrated information (PII) files;
identify elements corresponding to the one or more HTML files to be translated into a target language;
create a mapping file corresponding to the identified elements, wherein the mapping file indicates a PII file to which each identified element corresponds as well as context information corresponding to each PII file;
translate the PII files indicated by the mapping file into a target language to provide translated PII files; and
replace untranslated PII files in the HTML package with corresponding translated PII files to provide a translated package.

9. The computer program product of claim 8, wherein the instructions to identify elements within the one or more HTML files to be translated comprise instructions to identify elements that correspond to an HTML file that is configured to display text in a language other than the target language to a user.

10. The computer program product of claim 8, wherein the instructions to provide the translated package comprise instructions to provide the translated package to a rendering engine.

11. The computer program product of claim 8, wherein the instructions to translate the PII files indicated by the mapping file comprise instructions to:
identify a set of words within the indicated PII files that will be seen by a user when the corresponding HTML files are rendered; and
translate the set of words into a target language.

12. The computer program product of claim 8, further comprising instructions to verify the translated package.

13. The computer program product of claim 8, wherein context information corresponding to each PII file may include selected rendered HTML files corresponding to the PII file.

14. The computer program product of claim 8, wherein the instructions to create a mapping file corresponding to the identified elements comprise instructions to:
identify PII keys which correspond to multiple elements;
identify PII keys corresponding to related data in the HTML package; and
create a mapping file including all the identified PII keys and the elements to which they correspond.

15. A computer system comprising:
one or more computer processors;
one or more computer-readable storage media;
program instructions stored on the computer-readable storage media for execution by at least one of the one or more processors, the program instructions comprising instructions to:
receive an HTML package comprising one or more HTML files and one or more corresponding program integrated information (PII) files;
identify elements corresponding to the one or more HTML files to be translated into a target language;
create a mapping file corresponding to the identified elements, wherein the mapping file indicates a PII file to which each identified element corresponds as well as context information corresponding to each PII file;
translate the PII files indicated by the mapping file into a target language to provide translated PII files; and
replace untranslated PII files in the HTML package with corresponding translated PII files to provide a translated package.

16. The computer system of claim 15, wherein the instructions to identify elements within the one or more HTML files to be translated comprise instructions to identify elements that correspond to an HTML file that is configured to display text in a language other than the target language to a user.

17. The computer system of claim 15, wherein the instructions to provide the translated package comprise instructions to provide the translated package to a rendering engine.

18. The computer system of claim 15, wherein the instructions to translate the PII files indicated by the mapping file comprise instructions to:
identify a set of words within the indicated PII files that will be seen by a user when the corresponding HTML files are rendered; and
translate the set of words into a target language.

19. The computer system of claim 15, wherein context information corresponding to each PII file may include selected rendered HTML files corresponding to the PII file.

20. The computer system of claim 15, wherein the instructions to create a mapping file corresponding to the identified elements comprise instructions to:
identify PII keys which correspond to multiple elements;
identify PII keys corresponding to related data in the HTML package; and
create a mapping file including all the identified PII keys and the elements to which they correspond.
